(19) United States
(12) Patent Application Publication
(10) Pub. No.: US 2009/0161202 A1
(43) Pub. Date: Jun. 25, 2009

(54) APPARATUS FOR OPTICAL PARAMETRIC CHIRPED PULSE AMPLIFICATION (OPCPA) USING INVERSE CHIRPING AND IDLER

(75) Inventors: Hong Jin Kong, Daejeon (KR); Dong Won Lee, Daejeon (KR); Jin Choi, Seoul (KR); Du Hyun Beak, Seoul (KR); Jin Woo Yoon, Pusan (KR); Tae Hyung Kim, Daejeon (KR)

Correspondence Address: MAYER & WILLIAMS PC, 251 NORTH AVENUE WEST, 2ND FLOOR, WESTFIELD, NJ, 07090, US

(73) Assignee: KOREA ADVANCED INSTITUTE OF SCIENCE AND TECHNOLOGY, Daejeon (KR)

(21) Appl. No.: 12/302,760

(22) PCT Filed: Jan. 29, 2007
(86) PCT No.: PCT/KR2007/000493

§ 371 Date: Nov. 26, 2008

(30) Foreign Application Priority Data
May 26, 2006 (KR) 10-2006-0047352

(51) Int. Cl. H01S 3/00

(52) U.S. Cl. 359/345

(57) ABSTRACT

An OPCPA apparatus of the present invention includes an optical pulse stretcher (100) for temporally stretching laser light, and applying short-wavelength preceding-type chirping. Pump lasers (210, 220) emit pump laser light. A first OPA unit (310) receives the pump laser light, and a signal having passed through the optical pulse stretcher, amplifies the signal, and generates a first idler. A first optical signal separation unit (410) separates output light of the first OPA unit into the first idler and remaining light (pump and signal). A second OPA unit (320) receives the first idler and another pump laser light, amplifies the first idler, and generates a second idler. A second optical signal separation unit (420) separates output light of the second optical parametric amplification unit into an amplified first idler and remaining light (pump and second idler). An optical pulse compressor (600) temporally compresses the amplified first idler.

### TECHNICAL FIELD

The present invention relates, in general, to an Optical Parametric Chirped Pulse Amplification (OPCPA) apparatus and, more particularly, to an OPCPA apparatus using inverse chirping and an idler, which amplifies a mode-locked ultrashort laser source existing in a band ranging from several tens of femtoseconds (fs; 10⁻¹⁵ seconds) to several picoseconds (ps: 10⁻¹² seconds).

### BACKGROUND ART

Optical Parametric Chirped Pulse Amplification (OPCPA) is a new optical amplification technique of combining conventional Chirped Pulse Amplification (CPA) technology with the concept of Optical Parametric Amplification (OPA), and is laser amplification technology which has recently been actively researched.

In a conventional OPCPA apparatus, an antiparallel diffraction grating structure of applying long-wavelength preceding-type chirping (positive chirping by the antiparallelism of a grating pair) is first applied to an optical pulse stretcher, and a parallel diffraction grating structure of applying short-wavelength preceding-type chirping after amplification has been performed (negative chirping by the parallelism of a grating pair) is applied to an optical pulse compressor, so that the temporal stretch of a pulse occurring in the optical pulse stretcher is compensated for.

This structure is described in detail with reference to FIGS. 1 to 4.

FIG. 1 is a diagram showing the construction of a conventional OPCPA apparatus.

Referring to FIG. 1, the conventional OPCPA apparatus includes an optical pulse stretcher 10, pump-injection dichroic mirrors 81 and 82, pump lasers 21 and 22, Optical Parametric Amplification (OPA) units 31 and 32, pump-removal dichroic mirrors 41 and 42, beam dumpers 51 and 52, and an optical pulse compressor 60.

The optical pulse stretcher 10 temporally stretches laser light by varying the optical path of the laser light for each frequency. That is, the optical pulse stretcher 10 stretches the pulse length (pulse duration) of the output light of an ultrashort laser from an original band of several femtoseconds (fs; 10⁻¹⁵ seconds)/several tens of picoseconds (ps; 10⁻¹² seconds) to a stretch band of several hundreds of picoseconds (ps; 10⁻¹² seconds)/several nanoseconds (ns; 10⁻⁹ seconds) (in relation to this technology, refer to relevant CPA technology devised to realize efficient optical amplification and to avoid damage to optical parts).

In the present specification, the output light of the optical pulse stretcher 10 is also briefly referred to as a ‘signal’.

The detailed structure of the optical pulse stretcher 10 will be described later with reference to FIGS. 2 to 4, and thus a detailed description thereof is omitted.

The pump lasers 21 and 22 are devices for supplying pump laser light (also briefly referred to as a ‘pump’).

The pump-injection dichroic mirrors 81 and 82 are devices for receiving the pump and the signal, and transmitting the pump and the signal to a subsequent stage (OPA units).

The OPA units 31 and 32 amplify the signal using the pump, and generate an idler. Accordingly, the pump itself is attenuated to a corresponding degree by energy conservation.

Then, the output light of the OPA units 31 and 32 includes the pump, the amplified signal, and the idler.

Optical parametric amplification is classified into collinear phase matching and noncollinear phase matching according to the phase matching configuration between the pump and the signal. When a design condition is selected properly in the noncollinear phase matching configuration, a gain bandwidth broader than that of the collinear phase matching can be obtained. Accordingly, at the time of performing broadband Optical Parametric Amplification (broadband OPA), noncollinear phase matching is generally used. In this case, since it is difficult to subsequently use an idler due to angular dispersion according to wavelength, the idler is removed using a beam dumper.

The pump-removal dichroic mirrors 41 and 42 separate the output light of the OPA units 31 and 32 into a signal and remaining light (idler and pump), and vary the optical paths thereof.

For example, the pump-removal dichroic mirrors 41 and 42 reflect the signal, pass the idler and the pump therethrough, and remove she passed idler and pump using the beam dumpers 51 and 52.

Generally, since the output light, emitted from the ultrashort laser oscillator itself, has a very small amount of energy per pulse, the output light is amplified through several stages of amplification (OPA) units.

That is, the pump lasers 21 and 22, the OPA units 31 and 32, the pump-removal dichroic mirrors 41 and 42, and the beam dumpers 51 and 52 are provided in plural numbers, and thus amplification is performed until a signal having the desired intensity is obtained.

Therefore, in the present specification, the pump lasers 21 and 22, the pump-injection dichroic mirrors 81 and 82, the OPA units 31 and 32, the pump-removal dichroic mirrors 41 and 42, and the beam dumpers 51 and 52 are prefixed with ‘first and second’. That is, reference numeral 21 denotes a first pump laser, and reference numeral 22 denotes a second pump laser. Accordingly, light output from the first pump laser is designated as a first pump, and light output from the second pump laser is designated as a second pump.

As described above, when the amplification of the signal to desired intensity is performed, temporal compression is finally performed using the optical pulse compressor 60.

Reference numerals 71 to 74 are beam path changing mirrors for changing the paths of light (beam).

FIGS. 2 to 4 are diagrams showing the construction of the optical pulse stretcher of the conventional OPCPA apparatus, FIG. 2 illustrating an antiparallel diffraction grating structure (refraction type), FIG. 3 illustrating an antiparallel diffraction grating structure (reflection type), and FIG. 4 illustrating an antiparallel diffraction grating structure (Offner—triplet type).

Referring to FIG. 2, the refraction-type antiparallel diffraction grating structure includes two diffraction gratings (respectively designated as ‘first diffraction grating’ and ‘second diffraction grating’) 111 and 112, two lenses 113 and 114, and a single roof mirror 115.

The roof mirror 115 functions to reflect incident light at a changed height.

The optical path of the incident light is described. After light is incident on the first diffraction grating 111 and is diffracted from the first diffraction grating 111, the diffracted light passes through two lenses 113 and 114, and is then incident on and diffracted from the second diffraction grating 112. The diffracted light is incident on the roof mirror 115, and is reflected from the roof mirror 115 at a changed height. The reflected light is incident on the beam path changing mirror 71 through the second diffraction grating 112, the two lenses 114 and 113, and the first diffraction grating 111.

The refraction-type antiparallel diffraction grating structure of FIG. 2 may have the following problem. That is, in the refraction-type antiparallel diffraction grating structure including the lenses 113 and 114, chromatic aberration caused by the lenses, etc. may occur.

In order to solve the problem of chromatic aberration caused by the lenses, the reflection-type antiparallel diffraction grating structure of FIG. 3 has been devised.

Referring to FIG. 3, the reflection-type antiparallel diffraction grating structure includes two diffraction gratings (respectively designated as ‘first diffraction grating’ and ‘second diffraction grating’) 121 and 122, two cylinder mirrors 123 and 124, and a single roof prism 125.

The prism 125 performs the same function as the roof mirror of FIG. 2.

The optical path thereof is described. After light is incident on and diffracted from the first diffraction grating 121, the diffracted light passes through the two cylinder mirrors 123 and 124 and is then incident on and diffracted from the second diffraction grating 122. The diffracted light is incident on the roof prism (or the roof mirror) 125. The incident light is reflected from the roof prism 125 at a changed height. The reflected light is incident on the beam path changing mirror 71 through the second diffraction grating 122, the cylinder mirrors 124 and 123, and the first diffraction grating 121.

The reflection-type antiparallel diffraction grating structure may have the following problem. Specifically, a problem of aberration (such as astigmatism and coma) caused by the slopes of the two cylinder mirrors relative to the optical axis occurs.

In order to solve the above problem, an Offner-triplet structure of FIG. 4a (plan view) and FIG. 4b (side view) has been devised.

Referring to FIG. 4, the Offner-triplet structure includes a single diffraction grating 131, two spherical mirrors (respectively designated as ‘first spherical mirror’ and ‘second spherical mirror’) 132 and 133 having different sizes, and a single roof prism (or a single roof mirror) 134.

In the above construction, the roof prism 134 performs the same function as the roof mirror of FIG. 2.

The second spherical mirror 133 is larger than the first spherical mirror 132.

The optical path of the Offner-triplet structure is described. After light is incident on and diffracted from the diffraction grating 131, the diffracted light is incident on and reflected from the second spherical mirror 133. After the reflected light is incident on and diffracted from the first spherical mirror 132, the diffracted light is incident on and reflected from the second spherical mirror 133 again. The reflected light is incident on and reflected from the diffraction grating 131 again, and the reflected light is incident on the roof prism 134. The incident light is reflected from the roof prism 134 at a changed height. The reflected light passes through the diffraction grating 131, the second spherical mirror 133, and the first spherical mirror 132, and is then output through the second spherical mirror 133 and the diffraction grating 131.

Next, the operation and effects of the conventional OPCPA apparatus are described below.

First, light passes through the optical pulse stretcher 10 having the structure of FIGS. 2 to 4, and thus a waveform having a temporally stretched pulse, in which a long wavelength precedes a short wavelength, is output.

The output light (signal) of the optical pulse stretcher 10 is incident on the first pump-injection dichroic mirror 81 through the beam path changing mirrors 71 and 72, and the output light (pump) of the first pump laser 21 is also incident on the first pump-injection dichroic mirror 81.

Both the signal and the pump are incident on the first OPA unit 31. In the first OPA unit 31, an idler is generated while the signal is amplified by the pump, and thus the pump itself is attenuated.

Consequently, the output light of the first OPA unit 31 includes the pump, the amplified signal, and the idler.

The output light is incident on the first pump-removal dichroic mirror 41, and is separated into an amplified signal and remaining light (pump and idler). That is, both the attenuated pump and the idler pass through the first pump-removal dichroic mirror 41 and are removed by the first beam dumper 51, and the amplified signal is reflected from the first pump-removal dichroic mirror 41.

If the amplified signal succeeds in reaching the level of aimed intensity or more, the amplified signal is directly incident on the optical pulse compressor 60, otherwise, it undergoes the above process again (process from the pump-injection dichroic mirror to the beam dumper).

That is, if the signal (amplified signal) reflected from the first pump-removal dichroic mirror 41 fails in reaching the level of aimed intensity or more, the signal is incident on the other pump-injection dichroic mirror (second pump-injection dichroic mirror) 82, and the pump generated from the second pump laser 22 is also incident on the second pump-injection dichroic mirror 82. Thereafter, the above process is repeated until the above signal becomes a signal amplified to a predetermined intensity or more while passing through the second OPA unit 32, the second pump-removal dichroic mirror 42, and the second beam dumper.

Finally, the amplified signal is incident on the optical pulse compressor 60, and the optical pulse compressor 60 temporally compresses the amplified signal.

However, the conventional OPCPA apparatus has the following problems.

That is, the conventional OPCPA apparatus is problematic in that, since it uses the antiparallel diffraction grating structure (refraction type, reflection type, and Offner-triplet type) (refer to FIGS. 2 to 4) for the optical pulse stretcher, and uses the parallel diffraction grating structure (refer to FIG. 7) for the optical pulse compressor, the structure of the optical pulse structure is excessively complicated. Accordingly, there are problems in that the construction of the conventional OPCPA apparatus is complicated, the alignment of an optical system becomes difficult, and the construction cost is increased.

### DISCLOSURE OF THE INVENTION

Accordingly, the present invention has been made keeping in mind the above problems, and an object of the present invention is to provide an Optical Parametric Chirped Pulse Amplification (OPCPA) apparatus having a new structure differing from that of conventional OPCPA apparatuses while solving the problems with conventional OPCPA apparatuses (complication of a structure and increase of cost), through the following characteristics:

first, a parallel diffraction grating structure of applying short-wavelength preceding-type chirping, instead of an antiparallel diffraction grating structure of applying long-wavelength preceding-type chirping, is applied to an optical pulse stretcher,

second, an idler, instead of an amplified signal, among the output light of a first Optical Parametric Amplification (OPA) unit, is incident on a second OPA unit, and

third, a parallel diffraction grating structure identical to that used in the optical pulse stretcher is applied to an optical pulse compressor.

The above object of the present invention is described in detail. The present invention does not use an optical pulse stretcher, having a conventional complicated structure, but uses only a simple diffraction grating pair together with collinear phase matching configuration, temporally stretches laser light for frequency components in a direction inverse to that of conventional configuration (intentional inverse-chirping), and causes the laser light to pass through two-stage Optical Parametric Amplification (2-stage OPA). The present invention is intended to consequently obtain compressible chirped laser light (chirped optical pulses) from the previous stage of the optical pulse compressor using a method of taking only an idler generated by a primary amplification (OPA) unit while discarding the signal amplified by the primary OPA unit, and of using the taken idler as a signal for a subsequent amplification stage.

In particular, for the relationship between nearly overlapping signal and pump (nearly degenerated case), that is, signal wavelength (λₛ)/pump wavelength (λₚ)/idler wavelength (λᵢ), the prior art satisfies λₛ<2λₚ<λᵢ or λᵢ<2λₚ<λₛ, whereas the present invention satisfies λₛ≈2λₚ≈λᵢ, so that the present invention proposes a new concept of OPCPA that is very practical and has a very simple structure in order to allow most OPA gains to be broadband signal gains even at the time of performing collinear phase matching.

The reason why the use of an idler in an optical parametric amplification system has been difficult is described below.

First, since angular dispersion of an idler occurs in noncollinear phase-matching, beams spatially travel in different directions according to wavelength when traveling later, and thus it is difficult to find a means capable of sufficiently correcting the angular dispersion. Second, the problem of angular dispersion can be solved by matching the polarization of an idler with ordinary light (ordinary wave) while utilizing collinear phase matching to use the idler, but it is generally difficult to obtain sufficiently broadband gain to the extent that the gain is uniformly distributed throughout the broad spectrum of a signal. Third, in special cases, a broadband gain enabling sufficient amplification of the entire spectrum of a signal may be occasionally obtained in spite of collinear phase matching, but, in this case, an inversely chirped pulse relative to an amplified signal is obtained, and thus it is impossible to recover the width of the pulse to the original width using only a typical optical pulse compressor. Further, in order to compress and utilize pulses, a new optical pulse compressor, composed of a series of expensive optical parts each having a wide diameter, the processing of which is difficult, is required (the reason for this is that an optical pulse stretcher generally has a more complicated structure than an optical pulse compressor).

In order to accomplish the above object, the present invention provides an Optical Parametric Chirped Pulse Amplification (OPCPA) apparatus, comprising an optical pulse stretcher for temporally stretching laser light by changing an optical path thereof for each frequency, the optical pulse stretcher applying short-wavelength preceding-type chirping; one or more pump lasers for emitting pump laser light; a first optical parametric amplification unit for receiving the pump laser light, and a signal (signal light), having passed through the optical pulse stretcher, amplifying the signal using the pump laser light, and generating a first idler; a first optical signal separation unit for separating output light of the first optical parametric amplification unit into the first idler and remaining light (pump and signal); a second optical parametric amplification unit for receiving the first idler separated by the first optical signal separation unit, and pump laser light output from another pump laser, amplifying the first idler using the pump laser light, and generating a second idler; a second optical signal separation unit for separating output light of the second optical parametric amplification unit into an amplified first idler and remaining light (pump and second idler); and an optical pulse compressor for temporally compressing the amplified first idler, wherein the following relational expression must be satisfied under collinear phase matching, <relational expression>λₛ≈2λₚ≈λᵢ where λₛ is a wavelength of the signal, λₚ is a wavelength of the pump, and λᵢ is a wavelength of the idler.

Preferably, the optical pulse stretcher and the optical pulse compressor may have a same structure, and may have a parallel diffraction grating structure.

Preferably, the parallel diffraction grating structure may comprise two diffraction gratings having a parallel arrangement, and a single roof mirror for reflecting incident light at a changed height.

Preferably, the first and second optical parametric amplification units may use nonlinear optical media such as Beta Barium Borate(BBO), Lithium Triborate(LBO), Potassium Titanyl Phosphate(KTP), and Potassium Dihydrogen Phosphate(KDP).

Preferably, the OPCPA apparatus may further comprise a first pump-injection dichroic mirror placed upstream of the first optical parametric amplification unit, and constructed to have an anti-reflection coating for the wavelength of the pump and a broadband high-reflection coating for the wavelength of the signal; and a second pump-injection dichroic mirror placed upstream of the second optical parametric amplification unit, and constructed to have an anti-reflection coating for the wavelength of the pump, and a broadband high-reflection coating for the wavelength of the first idler corresponding to a signal of the second optical parametric amplification unit.

Preferably, the first optical signal separation unit may be a first pump-removal dichroic mirror for reflecting the first idler, output from the first optical parametric amplification unit, and passing the remaining light (first pump and signal) therethrough, thus separating the output light of the first optical parametric amplification unit into the first idler and the remaining light.

Preferably, the second optical signal separation unit may be a second pump-removal dichroic mirror for reflecting the amplified first idler, output from the second optical parametric amplification unit, and passing the remaining light (pump and second idler) therethrough, thus separating the output light of the second optical parametric amplification unit into the amplified first idler and the remaining light.

Preferably, the OPCPA apparatus may further comprise a first beam dumper for removing the pump and the signal separated by the first optical signal separation unit.

Preferably, the OPCPA apparatus may further comprise a second beam dumper for removing the pump and the second idler separated by the second optical signal separation unit.

Preferably, the OPCPA apparatus may further comprise a first beam path changing mirror installed downstream of the optical pulse stretcher and adapted to change a path of incident light toward the first pump-injection dichroic mirror.

Preferably, the OPCPA apparatus may further comprise a second beam path changing mirror for changing a path of light reflected from the second pump-removal dichroic mirror toward the optical pulse compressor.

### BRIEF DESCRIPTION OF THE DRAWINGS

FIG. 1 is a diagram showing the construction of a conventional Optical parametric Chirped Pulse Amplification (OPCPA) apparatus;

FIGS. 2 to 4 are diagrams showing the construction of the optical pulse stretcher of the conventional OPCPA apparatus;

FIG. 5 is a block diagram of an OPCPA apparatus according to the present invention;

FIG. 6 is a detailed diagram showing the construction of the OPCPA apparatus of FIG. 5;

FIG. 7 is a diagram showing the construction of the optical pulse stretcher of the OPCPA apparatus according to an embodiment of the present invention;

FIG. 8 illustrates examples of the application of the design of an OPCPA apparatus, designed to have a collinear phase matching configuration, which can be applied to the present invention;

FIG. 9 is a graph showing the chirped state of an original signal stretched by the optical pulse stretcher of the OPCPA apparatus according to the present invention;

FIGs. 10a and 10b are graphs respectively showing the chirped states of a signal and a first idler, which are the output light of the first OPA unit of the OPCPA apparatus according to the present invention; and

FIG. 11 is a graph showing the chirped state of an amplified first idler, which is the output light of the second OPA of the OPCPA apparatus according to the present invention.

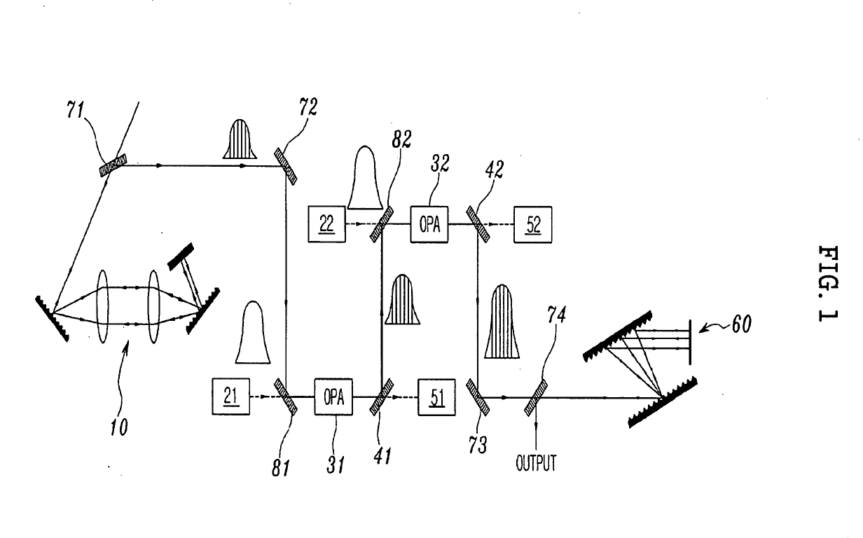

### DESCRIPTION OF REFERENCE CHARACTERS OF IMPORTANT PARTS

100: optical pulse stretcher
210, 220: pump laser
310, 320: optical parametric amplification (OPA) unit
410, 420: optical signal separation unit (pump-removal dichroic mirror)
510, 520: beam dumper
600: optical pulse compressor
710 to 740: beam path changing mirror
810, 820: pump-injection dichroic mirror

### BEST MODE FOR CARRYING OUT THE INVENTION

Hereinafter, embodiments of the present invention will be described in detail with reference to the attached drawings.

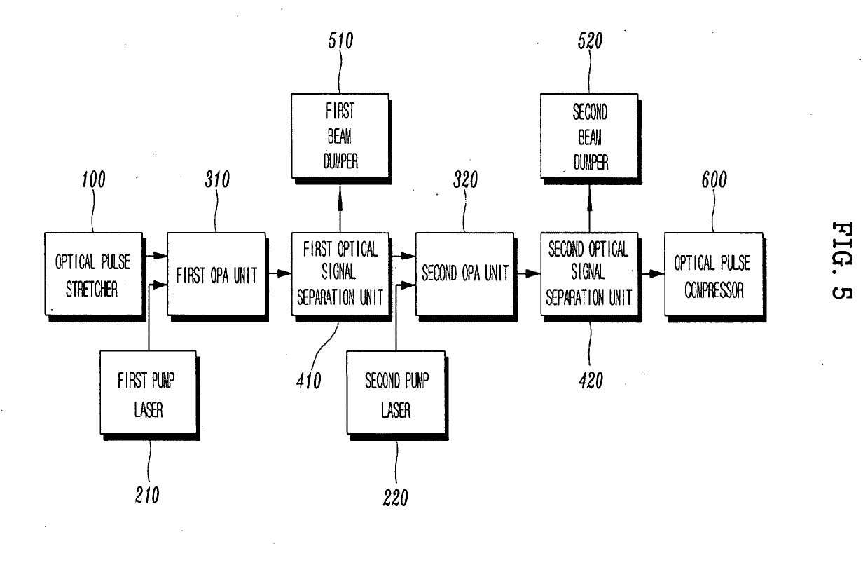

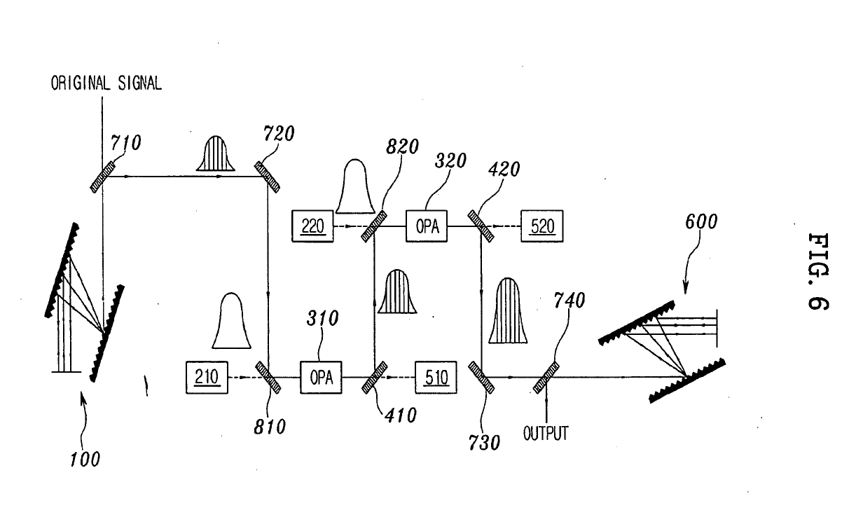

FIG. 5 is a block diagram of an Optical Parametric Chirped Pulse Amplification (OPCPA) apparatus according to the present invention, and FIG. 6 is a detailed diagram showing the construction of the OPCPA apparatus of FIG. 5.

Referring to FIGS. 5 and 6, the OPCPA apparatus according to the present invention includes an optical pulse stretcher 100, pump lasers 210 and 220, Optical Parametric Amplification (OPA) units 310 and 320, optical signal separation units 410 and 420, beam dumper units (beam dumpers) 510 and 520, and an optical pulse compressor 600.

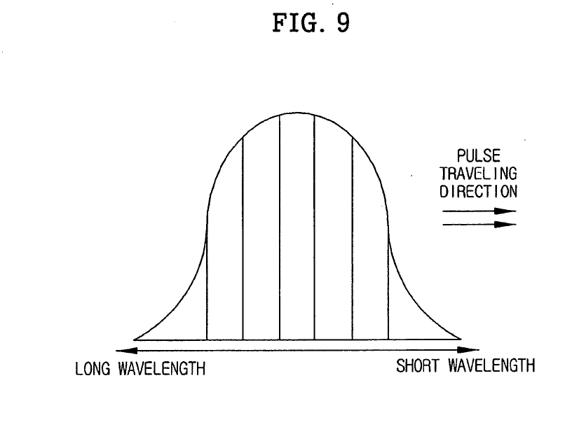

The optical pulse stretcher 100 is a device for temporally stretching laser light by varying the optical path thereof for each frequency, but applies short-wavelength preceding-type chirping (refer to FIG. 9). That is, the optical pulse stretcher 100 temporally stretches the length of the pulse (pulse duration) of the output light of an ultrashort laser from an original band of several femtoseconds (fs; 10⁻¹⁵ seconds)/several tens of picoseconds (ps; 10⁻¹² seconds) to a band of several hundreds of picoseconds (ps; 10⁻¹² seconds)/several nanoseconds (ns; 10⁻⁹ seconds).

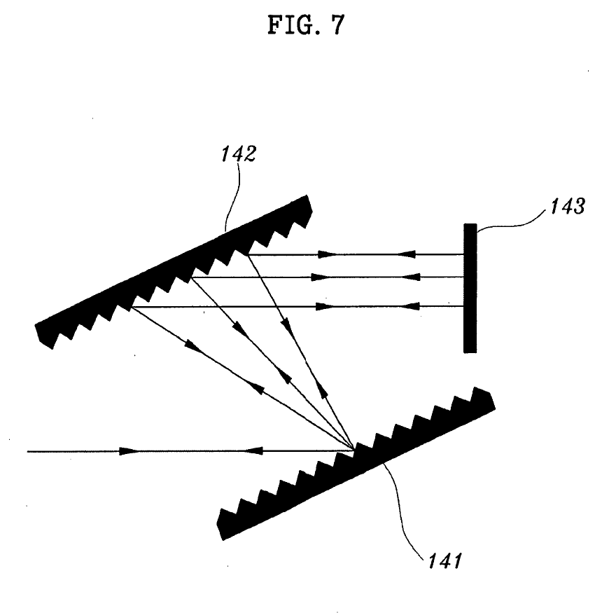

The structure of the optical pulse stretcher 100 will be described in detail with reference to FIG. 7, and thus a detailed description thereof is omitted.

The pump lasers 210 and 220 are devices for outputting pump laser light (pump), and two or more pump lasers (first, second, . . . , lasers) may be provided in the present invention.

The OPA units 310 and 320 amplify a signal using the pump, and generate an idler. Accordingly, the pump itself is attenuated to a corresponding degree.

In detail, the incident light of the first OPA unit 310 includes light output from the first pump laser 210 (first pump), and light output from the optical pulse stretcher 100 (signal), and the output light of the first OPA unit 310 includes an attenuated first pump, an amplified signal, and a first idler.

Further, the incident light of the second OPA unit 320 includes light output from the second pump laser 220 (second pump), and light separated by the first optical signal separation unit 410 (first idler), and the output light of the second OPA unit 320 includes an attenuated second pump, an amplified first idler, and a newly generated idler (second idler).

The OPA units 310 and 320 are preferably implemented using nonlinear optical media. The nonlinear optical media may include Potassium Titanyl Phosphate (KTP), Potassium Dihydrogen Phosphate (KDP), Lithium Triborate (LBO), Beta-Barium Borate (BBO), etc. The nonlinear optical media have an anti-reflection coating for the wavelengths of a pump, a signal, and an idler. In this case, the manufacture of nonlinear optical crystals and the design of phase matching configuration vary according to the wavelength of a pump and a signal.

The OPA unit realizes nearly degenerated signal-pump relationship. In the prior art, the relationship of λₛ<2λₚ<λᵢ or λₛ>2λₚ>λᵢ is generally satisfied, whereas, in the present invention, the relationship of λₛ≈2λₚ≈λᵢ must be satisfied.

In this case, λₛ denotes the wavelength of a signal, λₚ is the wavelength of a pump, and λᵢ is the wavelength of an idler.

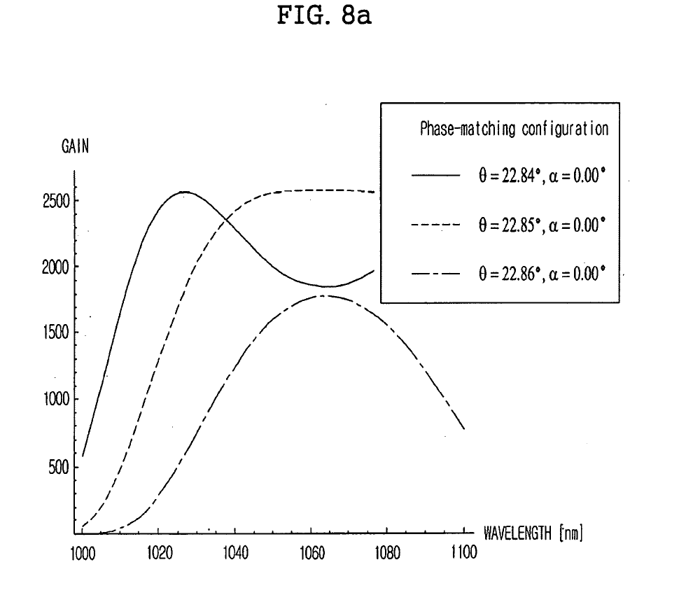

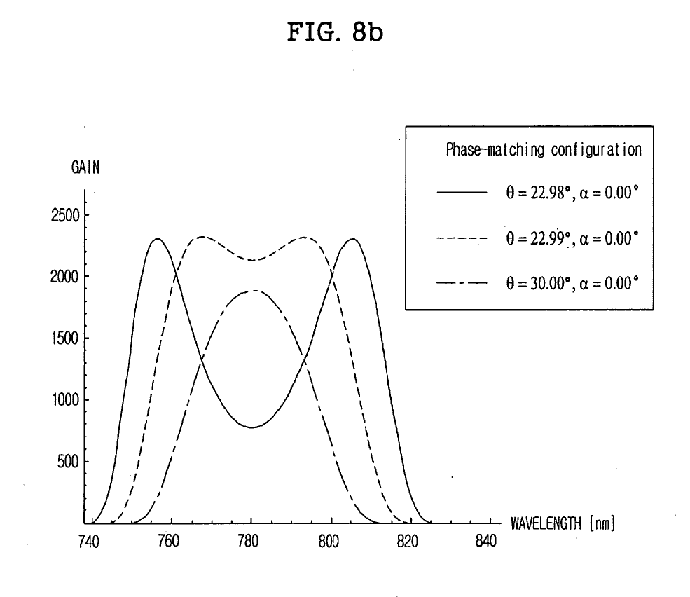

If the above relational expression is satisfied, most OPA gains can be obtained as broadband gains even under collinear phase matching (refer to FIG. 8).

Each of the optical signal separation units 410 and 420 separates optical signals into an optical signal that is desired to be removed and an optical signal that is desired to be transmitted to a subsequent stage. The beam dumpers 510 and 520 remove the optical signals that are desired to be removed and have been separated by the optical signal separation units 410 and 420, respectively.

The optical signal separation units 410 and 420 may include pump-removal dichroic mirrors, as an example, and the pump-removal dichroic mirrors function to pass light that is desired to be removed therethrough, and to reflect light that is desired to be transmitted to the subsequent stage.

In detail, the first pump-removal dichroic mirror 410 has a broadband high-reflection coating for the wavelength of the first idler, and has an anti-reflection coating for the wavelengths of the first pump and the signal. Accordingly, the incident light of the first pump-removal dichroic mirror is separated into the first idler and remaining light (signal and attenuated first pump) by the first pump-removal dichroic mirror.

Further, the second pump-removal dichroic mirror 420 has a broadband high-reflection coating for the wavelength of the first idler, and has an anti-reflection coating for the wavelengths of the pump and the second idler. Accordingly, the incident light of the second pump-removal dichroic mirror is separated into the amplified first idler and remaining light (second idler and second pump) by the second pump-removal dichroic mirror.

The signal and the attenuated first pump are removed by the first beam dumper 510, and the second idler and the second pump are removed by the second beam dumper 520.

Of course, the present invention can inversely perform the function of the pump-removal dichroic mirrors depending on the principles thereof. That is, the pump-removal dichroic mirrors may reflect light that is desired to be removed, and may pass light that is desired to be transmitted to the subsequent stage, and thus beam dumpers may be provided at a corresponding location in order to eliminate the reflected light. However, in practice, dichroic mirrors are preferably designed to reflect output light, which will be transmitted to the subsequent stage, in order to avoid the dispersion in output light.

In the present invention, the second pump laser 220, the second OPA unit 320, the second pump-removal dichroic mirror 420, and the second beam dumper 510 may be provided in plural numbers, so that amplification is performed until desired signal intensity is obtained.

The finally amplified optical signal is a signal amplified to have a wavelength differing from the wavelength of the original signal, and such a signal is temporally compressed by the optical pulse compressor 600.

The present invention may further include pump-injection dichroic mirrors 810 and 820 placed upstream of the OPA units 310 and 320 and adapted to receive a pump and a signal (or an idler) and to transmit the received light to the subsequent stage (OPA units).

In detail, the first pump-injection dichroic mirror 810 has an anti-reflection coating for the wavelength of a pump, and has a broadband high-reflection coating for the wavelength of a signal. Further, the second pump-injection dichroic mirror 820 has an anti-reflection coating for the wavelength of a pump, and has a broadband high-reflection coating for the wavelength of the first idler corresponding to the signal of the second OPA unit. Accordingly, the pump-injection dichroic mirrors function to transmit two received light beams to the OPA units.

Further, in the present invention, a plurality of beam path changing mirrors 710 to 740 is installed, thus allowing light output from the previous stage to progress to the subsequent stage.

The beam path changing mirrors 710 to 740 must have a broadband high-reflection coating for the entire wavelength band of the signal, and function to change the path of the incident signal.

The beam path changing mirrors are described in detail using an example. The beam path changing mirrors 710 and 720 can be installed downstream of the optical pulse stretcher 100 to change the path of incident light toward the first pump-injection dichroic mirror 810. Further, the beam path changing mirror 730 can be installed downstream of the second pump-removal dichroic mirror 420 to change the path of incident light toward the optical pulse compressor.

Further, when OPA of the present invention is performed, even-order dispersion (Group Velocity Dispersion: GVD, Fourth-Order Dispersion: FOD, etc.) between a signal and an idler is characterized in that a sign is changed to an opposite sign, and odd-order dispersion (Third-Order Dispersion: TOD, etc.) is characterized in that a signal is maintained without change. Accordingly, odd-order dispersion generated by diffraction grating pairs is accumulated in the structure of the present invention. However, since the accumulated odd-order dispersion can be easily compensated for using a commercial Acousto-Optic filter (for example, a commercial Acousto-Optic Programmable Dispersive Filter: AOPDF, a Dazzler, etc.) or a chirp mirror, which has recently and frequently been utilized, there is no problem with the present invention.

FIG. 7 is a diagram showing the construction of the optical pulse stretcher of the OPCPA apparatus according to an embodiment of the present invention, which shows a parallel diffraction grating structure.

In the present invention, the optical pulse stretcher and the optical pulse compressor have the same structure.

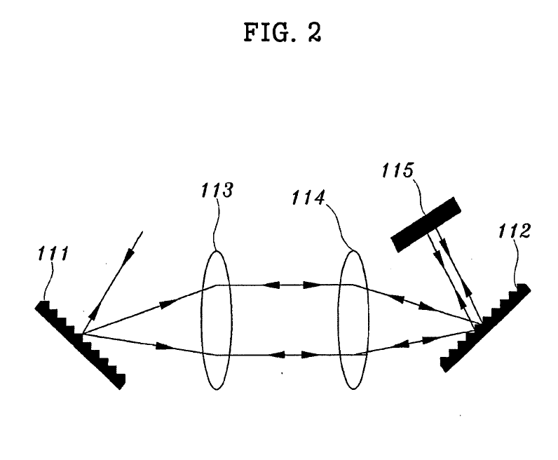

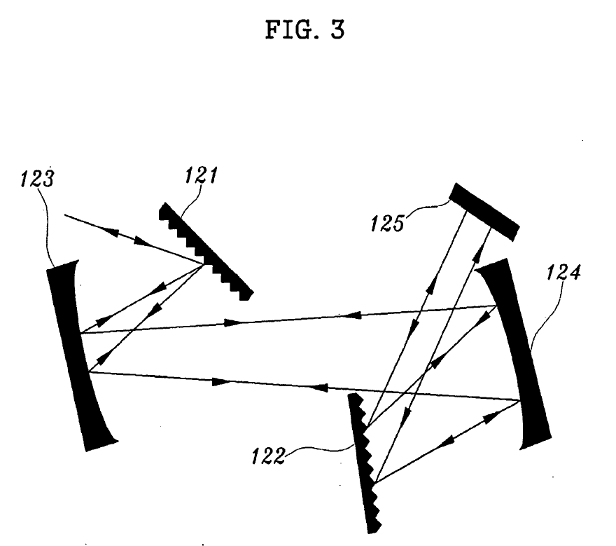

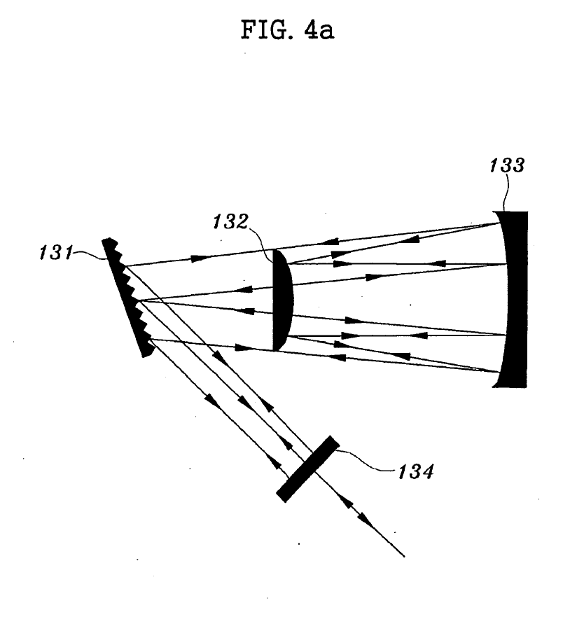

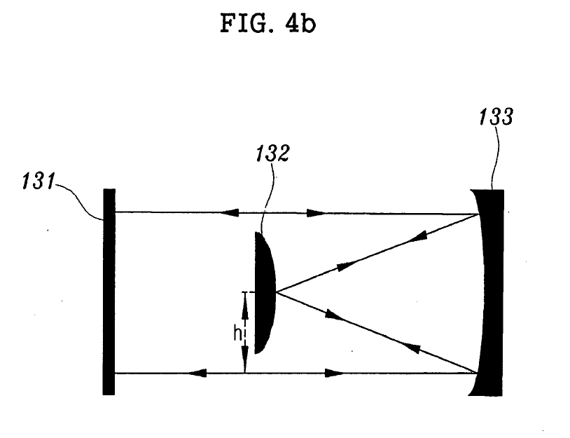

For example, the refraction (reflection)-type antiparallel diffraction grating structure of FIGS. 2 and 3 can be used together both in the optical pulse stretcher and in the optical pulse compressor, and the Offner-triplet antiparallel diffraction grating structure of FIG. 4 can also be used.

However, in the present invention, a parallel diffraction grating structure having the simple structure of FIG. 7 is preferably used both for the optical pulse stretcher and for the optical pulse compressor, rather than the antiparallel diffraction grating structure of FIGS. 2 to 4.

Referring to FIG. 7, the parallel diffraction grating structure includes two diffraction gratings 141 and 142 having a parallel arrangement, and a single roof mirror 143 for reflecting incident light at a changed height. The optical path thereof is described below. After light is incident on and diffracted from the first diffraction grating 141, the diffracted light is incident on and diffracted from the second diffraction grating 142. The diffracted light is incident on the roof mirror 143, and is reflected from the mirror 143 at a changed height. The reflected light is output through the second diffraction grating 142 and the first diffraction grating 141.

FIG. 8 illustrates examples of the application of the design of the OPCPA apparatus designed to have a collinear phase matching configuration that can be utilized in the present invention.

FIGS. 8a and 8b are graphs showing parametric-gain curves for the OPA units. FIG. 8a is a graph obtained when is the intensity of a pump is 400 MW/cm², the length of the BBO crystal is 15 mm, and the wavelength of the pump is 532 nm, and can be utilized for amplifying a signal having a center wavelength ranging from 1045 nm to 1085 nm. FIG. 8b is a graph obtained when the intensity of a pump is 400 MW/cm², the length of the BBO crystal is 11 mm, and the wavelength of the pump is 390 nm, and can be utilized for amplifying a signal having a center wavelength ranging from 770 nm to 790 nm (for the two cases, the same phase matching corresponding to type I, in which the polarizations of both a signal and an idler are ordinary waves, is used).

In detail, FIGS. 8a and 8b illustrate optical parametric amplification gains (parametric gains). For example, the solid line of FIG. 8a indicates an amplification gain curve obtained through an amplification stage which is designed at θ=22.84° and α=0°, and shows that a signal amplification gain of about 2500 times is obtained with respect to a signal having a wavelength of 1030 nm, and a signal amplification gain of about 1800 times is obtained with respect to a signal having a wavelength of 1050 nm.

For reference, the solid line of FIG. 8a indicates the gain curve obtained when θ=22.84° and α=0°, the dotted line thereof indicates the gain curve obtained when θ=22.85° and α=0°, and the one-dot chain line thereof indicates the gain curve obtained when θ=22.86° and α=0°.

Further, the solid line of FIG. 8b indicates the gain curve obtained when θ=29.98° and α=0°, the dotted line thereof indicates the gain curve obtained when θ=29.99° and α=0°, and the one-dot chain line thereof indicates the gain curve obtained when θ=23.00° and α=0°. In this case, θ denotes the angle between the optical axis of crystal and the pump, and a denotes the angle between the pump and the signal.

The present invention uses collinear phase matching to utilize an idler, which must satisfy the following condition (relational expression), as described above.

<Condition>

λₛ≈2λₚ≈λᵢ

where λ₀ is the wavelength of a signal, λₚ is the wavelength of a pump, and λᵢ is the wavelength of an idler.

If the above condition is satisfied, the OPA gain can be obtained as a broadband gain even at the time of performing collinear phase matching.

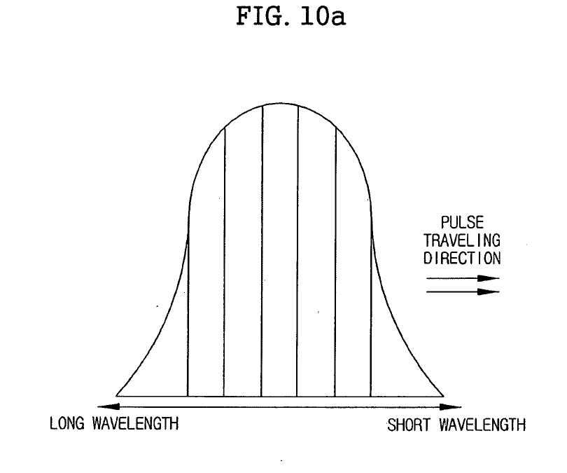

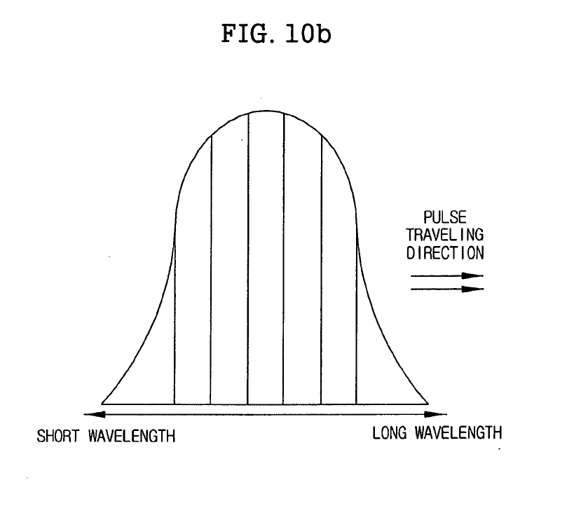

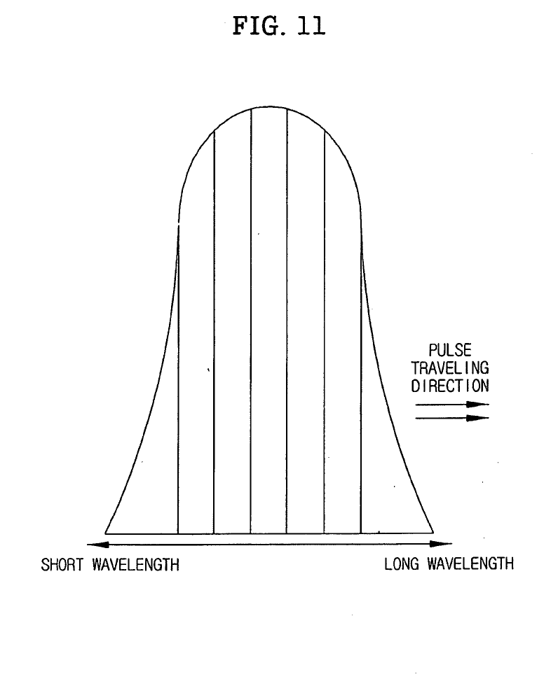

FIG. 9 is a graph showing the chirped state of an original signal, stretched by the optical pulse stretcher of the OPCPA apparatus according to the present invention, and FIGS. 10a and 10b are graphs respectively showing the chirped states of a signal and a first idler, which are the output light of the first OPA unit of the OPCPA apparatus according to the present invention. FIG. 11 is a graph showing the chirped state of an amplified first idler, which is the output light of the second OPA unit of the OPCPA apparatus according to the present invention.

Referring to the drawings, if a single pulse passes through the optical pulse stretcher 100, the pulse becomes a stretched original signal, as shown in FIG. 9. This signal is chirped in a direction inverse to that of the signal having passed through the conventional optical pulse stretcher 10. That is, in the prior art, a pulse passes through an antiparallel diffraction grating structure for applying long-wavelength preceding-type chirping, whereas a pulse passes through a parallel diffraction grating structure for applying short-wavelength preceding-type chirping.

When the pulse having such a waveform passes through the first OPA unit 310, the amplified signal (refer to FIG. 10a) and the idler (refer to FIG. 10b) are generated.

The idler has a structure in which a long wavelength precedes a short wavelength.

As described above, the present invention is constructed so that, of the output light of the first OPA unit 310, both the signal and the pump are separated and removed, and the first idler is selected and transmitted to the subsequent stage (second OPA unit).

When the first idler passes through the second OPA unit 320, the amplified idler is generated, as shown in FIG. 11.

The operation and effects of the OPCPA apparatus according to the present invention having the above construction are described below.

Laser light passing through the optical pulse stretcher 100 having the structure of FIG. 7 has a form that temporally stretches according to wavelength. The optical pulse stretcher 100 uses a scheme of applying short-wavelength preceding-type chirping, and thus the waveform of FIG. 9 is output.

The output light (signal) of the optical pulse stretcher 100 is incident on the first pump-injection dichroic mirror 810 through the beam path changing mirrors 710 and 720, and the output light (first pump) of the first pump laser 210 is also incident on the first pump-injection dichroic mirror 810.

The signal and pump are simultaneously incident on the first OPA unit 310. In this case, as the signal is amplified using the pump, an idler is generated, and the pump itself is attenuated.

Consequently, the output light of the first OPA unit includes the attenuated first pump, the amplified signal, and the first idler.

The output light is incident on the first pump-removal dichroic mirror 410, and is separated into a first idler and remaining light (first pump and signal). The first pump and signal pass through the first pump-removal dichroic mirror 410, and are removed by the first beam dumper 510, and the first idler is reflected from the first pump-removal dichroic mirror 410.

The first idler is incident on the other pump-injection dichroic mirror (second pump-injection dichroic mirror 820), and the pump, generated by the second pump laser 220 (second pump), is also incident on the second pump-injection dichroic mirror 820.

The first idler and the second pump are incident on the second OPA unit 320. In this case, as the first idler is amplified using the pump, a new idler (second idler) is generated, and the second pump itself is attenuated.

Consequently, the output light of the second OPA unit 320 includes the attenuated second pump, the amplified first idler, and the second idler.

The output light is incident on the second pump-removal dichroic mirror 420, and is separated into a first idler and remaining light (second pump and second idler). That is, the second pump and the second idler pass through the second pump-removal dichroic mirror 420, and are removed by the second beam dumper, and the amplified first idler is reflected from the second pump-removal dichroic mirror 420.

The amplified first idler corresponds to a signal that is amplified to have a wavelength that differs from that of an original signal.

When the amplified first idler is light amplified to a predetermined intensity or more, the amplified first idler is incident on the optical pulse compressor, otherwise the amplified first idler undergoes the above process (process from the second pump-injection dichroic mirror to the second beam dumper).

If the first idler is light which is finally amplified to a predetermined intensity or more, the first idler is incident on the optical pulse compressor 600, and the optical pulse compressor 600 temporally compresses the amplified idler.

### INDUSTRIAL APPLICABILITY

Accordingly, the present invention is advantageous in that the optical pulse stretcher used in the present invention has a structure simpler than that of a conventional optical pulse stretcher, and thus the structure of the OPCPA apparatus is further simplified. Further, there are advantages in that the alignment of an optical system is facilitated, the stability of the entire optical system is improved, and the manufacturing cost thereof is decreased.

In addition, the present invention is advantageous in that a considerable amount of dispersion, occurring when light passes through an optical medium, can be canceled through a conversion structure, such as long wavelength-short wavelength conversion or short wavelength-long wavelength conversion.

Further, the conventional OPCPA apparatus selectively amplifies a signal and noise by the amplification factor of the OPA unit, and thus it has an advantage in that the Signal-to-Noise Ratio (SNR) is improved compared to a typical CPA unit, whereas, if the structure of the present invention is used, the present invention has a structure of performing amplification using an idler generated by the signal, so that it can be predicted that the amplification of noise can be further eliminated, with the concomitant improvement of SNR corresponding to the amplification factor, and thus the present invention provides a solution to the problem of pre-pulse that occurs in the focusing of a high power laser on a target.

1. An Optical Parametric Chirped Pulse Amplification (OPCPA) apparatus, comprising:
an optical pulse stretcher for temporally stretching laser light by changing an optical path thereof for each frequency, the optical pulse stretcher applying short-wavelength preceding-type chirping;
one or more pump lasers for emitting pump laser light;
a first optical parametric amplification unit for receiving the pump laser light, and a signal (signal light), having passed through the optical pulse stretcher, amplifying the signal using the pump laser light, and generating a first idler;
a first optical signal separation unit for separating output light of the first optical parametric amplification unit into the first idler and remaining light (pump and signal);
a second optical parametric amplification unit for receiving the first idler separated by the first optical signal separation unit, and pump laser light output from another pump laser, amplifying the first idler using the pump laser light, and generating a second idler;
a second optical signal separation unit for separating output light of the second optical parametric amplification unit into an amplified first idler and remaining light (pump and second idler); and
an optical pulse compressor for temporally compressing the amplified first idler,
wherein the following relational expression must be satisfied under collinear phase matching,
<Relational Expression>
λₛ≈2λₚ≈λᵢ
where λₛ is a wavelength of the signal, λₚ is a wavelength of the pump, and λᵢ is a wavelength of the idler.

2. The OPCPA apparatus according to claim 1, wherein the optical pulse stretcher and the optical pulse compressor have a same structure.

3. The OPCPA apparatus according to claim 1 or 2, wherein the optical pulse stretcher and the optical pulse compressor have a parallel diffraction grating structure.

4. The OPCPA apparatus according to claim 3, wherein the parallel diffraction grating structure comprises two diffraction gratings having a parallel arrangement, and a single roof mirror for reflecting incident light at a changed height.

5. The OPCPA apparatus according to claim 1, wherein the first and second optical parametric amplification units use nonlinear optical media.

6. The OPCPA apparatus according to claim 1, further comprising:
a first pump-injection dichroic mirror placed upstream of the first optical parametric amplification unit, and constructed to have an anti-reflection coating for the wavelength of the pump and a broadband high-reflection coating for the wavelength of the signal; and
a second pump-injection dichroic mirror placed upstream of the second optical parametric amplification unit, and constructed to have an anti-reflection coating for the wavelength of the pump, and a broadband high-reflection coating for the wavelength of the first idler corresponding to a signal of the second optical parametric amplification unit.

7. The OPCPA apparatus according to claim 1, wherein the first optical signal separation unit is a first pump-removal dichroic mirror for reflecting the first idler, output from the first optical parametric amplification unit, and passing the remaining light (first pump and signal) therethrough, thus separating the output light of the first optical parametric amplification unit into the first idler and the remaining light.

8. The OPCPA apparatus according to claim 1, wherein the second optical signal separation unit is a second pump-removal dichroic mirror for reflecting the amplified first idler, output from the second optical parametric amplification unit, and passing the remaining light (pump and second idler) therethrough, thus separating the output light of the second optical parametric amplification unit into the amplified first idler and the remaining light.

9. The OPCPA apparatus according to claim 1 or 7, further comprising a first beam dumper for removing the pump and the signal separated by the first optical signal separation unit.

10. The OPCPA apparatus according to claim 1 or 8, further comprising a second beam dumper for removing the pump and the second idler separated by the second optical signal separation unit.

11. The OPCPA apparatus according to claim 6, further comprising a first beam path changing mirror installed downstream of the optical pulse stretcher and adapted to change a path of incident light toward the first pump-injection dichroic mirror.

12. The OPCPA apparatus according to claim 8, further comprising a second beam path changing mirror for changing a path of light reflected from the second pump-removal dichroic mirror toward the optical pulse compressor.
